(19) United States
(12) Patent Application Publication
(10) Pub. No.: US 2008/0065721 A1
(43) Pub. Date: Mar. 13, 2008

(54) PROXIMITY-BASED WEB PAGE CONTENT PLACEMENT MECHANISM

(76) Inventor: Brian John Cragun, Rochester, MN (US)

Correspondence Address: MARTIN & ASSOCIATES, LLC, P.O. BOX 548, CARTHAGE, MO, 64836-0548, US

(21) Appl. No.: 11/531,060

(22) Filed: Sep. 12, 2006

(51) Int. Cl. G07G 1/14; G06F 15/16

(52) U.S. Cl. 709/203; 709/218; 705/14

(57) ABSTRACT

A web page server places content-based selections at locations on a web page based on proximity of a content-based selection location to content that influenced selection of the content-based selection. The content is analyzed according to its location, and is assigned a corresponding content-based selection location or is shared by multiple content-based selection locations. Content for a given content-based selection location is then selected based on the content that corresponds to the content-based selection location. In this manner content-based selections are placed closer to the content that influenced their inclusion on the web page, thereby increasing the likelihood of the user seeing the ad and purchasing the advertised goods or services.

### BACKGROUND

1. Technical Field

This disclosure generally relates to the rendering of web pages to a user, and more specifically relates to the strategic placement of content on a web page.

2. Background Art

In modern networked computer systems, one or more of the computers on the network may be coupled to other computer networks, such as the internet. The internet grew out of a proliferation of computers and networks, and has evolved into a sophisticated worldwide network of computer system resources commonly known as the “world-wide-web”, or WWW. A user at an individual PC (i.e., workstation) that wishes to access the internet typically does so using a software application known as a web browser. A web browser makes a connection via the internet to other computers known as web servers, and receives information from the web servers that is displayed on the user's workstation. Information transmitted from the web server to the web browser is generally formatted using a specialized language called Hypertext Markup Language (HTML) and is typically organized into pages known as web pages. Many web pages include several individual components, such as text, banners, graphical images, Java applets, audio links, video links, and other components that present the web page to the user in a desired way. A designer of a web page can select a unique combination of components to provide the user with a desired overall presentation of the web page.

The internet has become a very popular medium for promoting the goods and services of a wide array of companies. Advertisements and other promotional items are often placed on web pages in an attempt to influence the user to buy certain products or to request information regarding products and services. Recent advances in web commerce allow advertisements to be rendered based on the content of a page. For example, Google is a popular search engine that provides advertisements based on the contents of search results. In this manner, advertisements may be specifically tailored to the content of a web page so the likelihood of the user purchasing the advertised product or service is increased. Advertisements are one example of a content-based selection for a web page, and advertisement locations are one example of a content-based selection location for a web page.

Current methods for rendering advertisements on a web page use sophisticated algorithms to place ads according to all of the content on the web page. Ads are then displayed in the predefined ad locations on the page. For example, a web page could have a top banner, a bottom banner, and two side ad locations. We'll assume for this example that the top and bottom banners are reserved for advertisers that have purchased a premium advertising package, and the two side ad locations are for advertisers that have purchased a less expensive advertising package. Known methods for placing ads in these four ad locations on this example web page would analyze all of the content on the web page, determine which ads are candidates for the banner ad locations and which are candidates for the side ad locations. Two banner ads may then be placed in the two banner ad locations, and two other ads may be placed in the two side ad locations. While many sophisticated methods are known for analyzing web page content and selecting ads for display on the web page, none of the known methods place ads in proximity to certain content on the web page. As a result, an ad that was triggered by certain content on the web page may be a long distance from the triggering content, reducing the likelihood that a user will see the ad and purchase the advertised goods or services.

### BRIEF SUMMARY

A web page server places advertisements at ad locations on a web page based on the proximity of an ad location to the content that influenced selection of the ad. The content is analyzed according to its location, and is assigned a corresponding ad location or is shared by multiple ad locations. An ad for a given ad location is then selected based on the content that corresponds to the ad location. In this manner ads are placed closer to the content that influenced their inclusion on the web page, thereby increasing the likelihood of the user seeing the ad and purchasing the advertised goods or services.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that includes a proximity-based web page ad placement mechanism that places ads on a web page according to the proximity of the ad to the content that influenced selection of the ad;

FIG. 2 is a simplified block diagram showing a first sample web page that includes two content portions and two ad locations;

FIG. 3 is a flow diagram of a prior art method for a web server to select and place ads in a web page based on the content of the web page;

FIG. 4 is a flow diagram of a method for performing proximity-based placement of ads on a web page;

FIG. 5 is a flow diagram of one suitable implementation of step 420 in FIG. 4;

FIG. 6 is a flow diagram of one suitable implementation of step 550 in FIG. 5;

FIG. 7 is a simplified block diagram showing a second sample web page showing how ads may be placed in the web page according to proximity to the content that influenced selection of the ad;

FIG. 8 is a table that illustrates the structure of a third sample web page;

FIG. 9 is a table that illustrates how the shared content in FIG. 8 may be split and assigned to corresponding ad locations;

FIG. 10 is a table that illustrates the structure of a fourth sample web page;

FIG. 11 is a table that illustrates the structure of a fifth sample web page;

FIG. 12 is a table that illustrates the structure of a sixth sample web page;

FIG. 13 is a table that illustrates the structure of a seventh sample web page;

FIG. 14 is a table that illustrates the structure of an eighth sample web page that includes a table within a table; and

FIG. 15 is a table showing one suitable scoring system for assigning content to ad locations for the table in FIG. 14.

### DETAILED DESCRIPTION

A web page server places advertisements at ad locations on a web page based on the proximity of an ad location to the content that influenced selection of the ad. A plurality of content regions on the web page are analyzed according to location, and are each assigned a corresponding ad location or designated as shared by multiple ad locations. An ad for a given ad location is then selected based on the content that corresponds to the ad location. In this manner ads are placed closer to the content that influenced their inclusion on the web page, thereby increasing the likelihood of the user seeing the ad and purchasing the advertised goods or services.

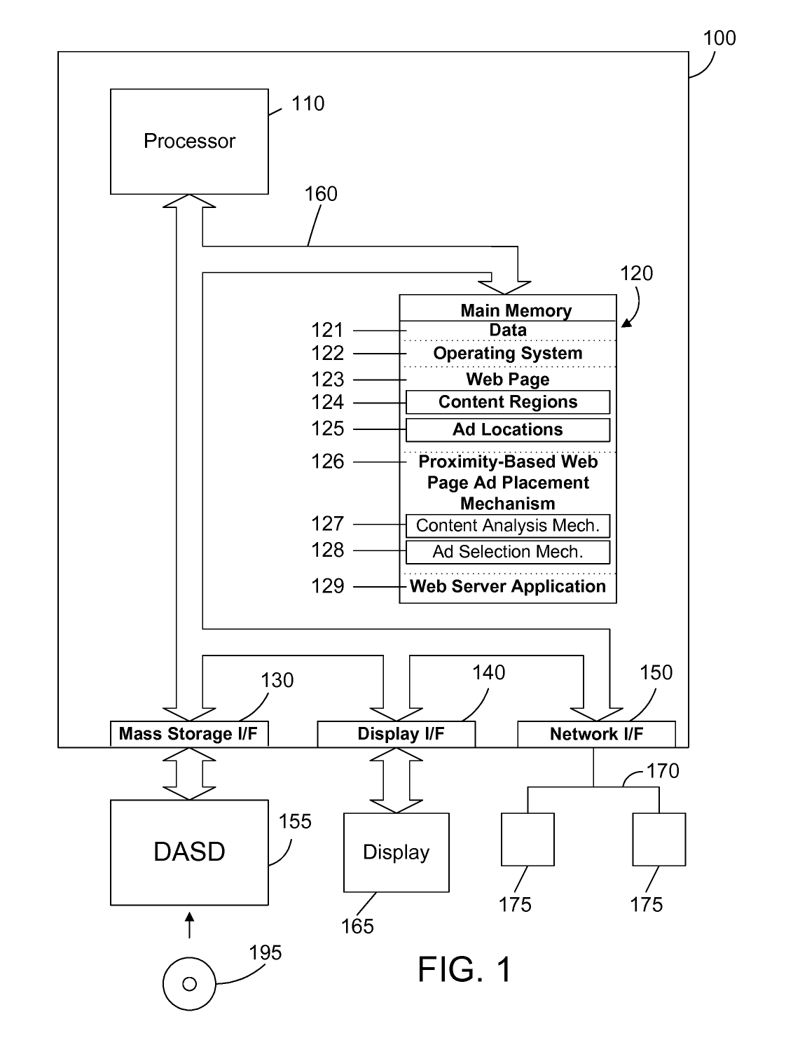

Referring to FIG. 1, a computer system 100 is one suitable implementation of an apparatus that performs proximity-based placement of ads in a web page. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, a web page 123, and a proximity-based web page ad placement mechanism 126. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Web page 123 includes a plurality of content regions 124 and a plurality of ad locations 125. The plurality of content regions 124 includes the content that the user desires to see when the user requests the web page 123. The plurality of ad locations 125 include advertisements (or ads) that are provided to the user as a marketing tool. Note that the term “ad” is used extensively herein as an abbreviated form of the word “advertisement.”

In the most preferred implementation, computer system 100 is a web server computer system that hosts a plurality of web pages and renders the web pages upon request to a user. As such, the computer system 100 preferably includes a web server application 129 in memory 120 that uses the proximity-based web page ad placement mechanism 126 to determine where to place ads on a web page 123. Note that the proximity-based web page ad placement mechanism 126 could be included as part of web server application 129, or could be a separate utility that may be invoked by the web server application 129 (as shown in FIG. 1).

The proximity-based web page ad placement mechanism 126 includes a content analysis mechanism 127 and an ad selection mechanism 128. The content analysis mechanism 127 preferably identifies which of the content regions 124 correspond to each of the ad locations 125. The ad selection mechanism 128 then selects an ad location, evaluates the content in the content regions 124 that correspond to the selected ad location, and determines which ad to place in the selected ad location based on the content in the corresponding content regions 124. Note that the ad selection mechanism 128 may use known methods for selecting an ad based on identified content. The content analysis mechanism 127, however, uses novel and non-obvious methods for identifying which content regions on a web page correspond to each ad location so the content that drives the selection of an ad at a particular ad location is based on proximity of the content to the ad location. In this manner ads are rendered on a web page at locations according to the proximity of the ads to the content that influenced their selection.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, web page 123, and proximity-based web page ad placement mechanism 126 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that proximity-based ad placement in a web page may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. Network interface 150 and network 170 broadly represent any suitable way to interconnect computer systems, regardless of whether the network 170 comprises present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the description above is in the context of a fully functional computer system, those skilled in the art will appreciate that the inbound packet filter mechanism may be distributed as a program product in a variety of forms, and that the claims extend to all suitable types of computer-readable media used to actually carry out the distribution. Examples of suitable computer-readable media include: recordable media such as floppy disks and CD-RW (e.g., 195 of FIG. 1), and transmission media such as digital and analog communications links.

Embodiments of the present invention may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

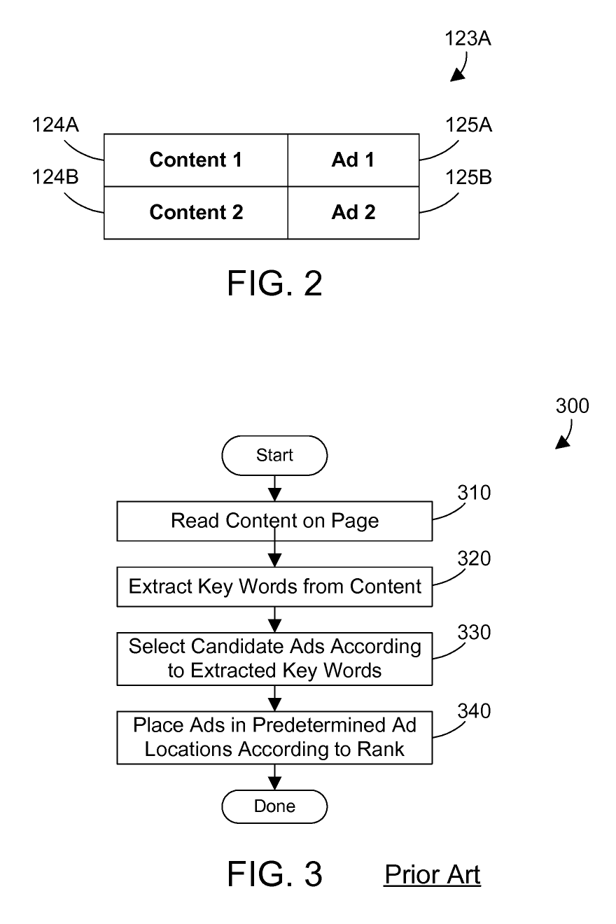

FIG. 2 is a simplified representation of a table-based web page 123A that includes two content locations 124A and 124B and two ad locations 125A and 125B. Referring to FIG. 3, a prior art method 300 for placing ads in ad locations on a web page begins by reading the content on the page (step 310). Thus, for the sample web page 123A in FIG. 2, the content in both content locations 124A and 124B is read in step 310 in FIG. 3. Key words are then extracted from the content (step 320). Candidate ads are then selected (step 330) according to the key words that were extracted from the content in step 320. Some of the candidate ads are then placed in predetermined ad locations in the web page (step 340). For the example web page 123A in FIG. 2, a list of candidate ads is determined in step 330 according to the key words extracted from both content locations 124A and 124B, and two of the candidate ads are selected for the two ad locations 125A and 125B. One of the salient features of prior art method 300 is that all of the content on a page is read in step 310, and the ads are then selected based on all of the content on the page. The proximity-based web page ad placement mechanism 126 improves upon the prior art by selecting ads based on proximity of identified content to the ad location.

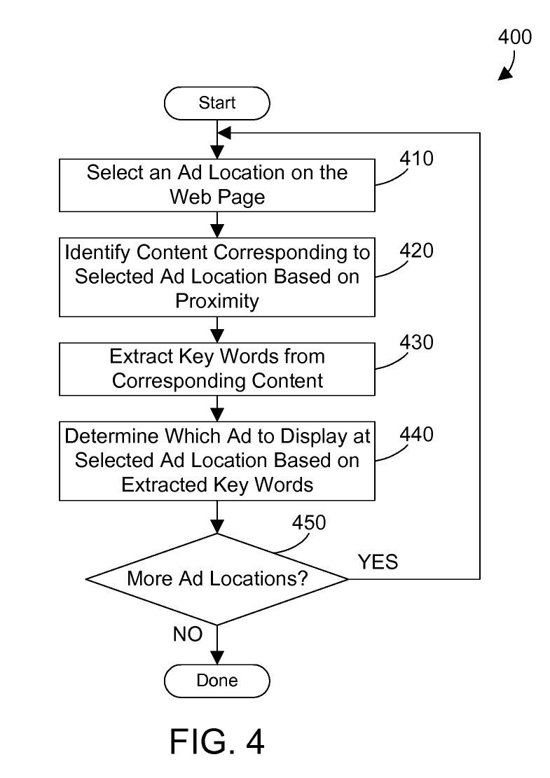

Referring to FIG. 4, a method 400 for providing proximity-based ad placement on a web page begins by selecting an ad location on the web page (step 410). Next, the content corresponding to the selected ad location is identified based on proximity of the content to the ad location (step 420). Key words are then extracted from the corresponding content (step 430), and an ad is selected for display at the selected ad location based on the extracted key words for the corresponding content (step 440). If there are more ad locations to process (step 450=YES), method 400 loops back to step 410 and continues. Once all ad locations have been processed (step 450=NO), method 400 is done.

One of the differences between method 400 in FIG. 4 and prior art method 300 in FIG. 3 is that only certain identified content is used to influence selection of which ads go in each ad location. This means that not all of the content on a web page is necessarily used for selecting each ad for each ad location. This allows a more regional approach on the web page, where content in identified regions that are in proximity to an ad location influence the selection of the ad in that ad location, while content in other identified regions that correspond to a different ad location will influence the selection of the ad in the different ad location. The result is a more fine-grained approach that tailors an ad at a particular ad location to the content that corresponds to that ad according to proximity of the content to the ad location on the web page.

Note that the determination of which ad to display in step 440 of FIG. 4 could use prior art methods for selecting an ad based on identified content, but the identified content will be selected according to proximity of the content to an ad location in step 420. The result is the placement of ads on a web page closer to the content that influenced their selection, thus resulting in more effective ads on a web page.

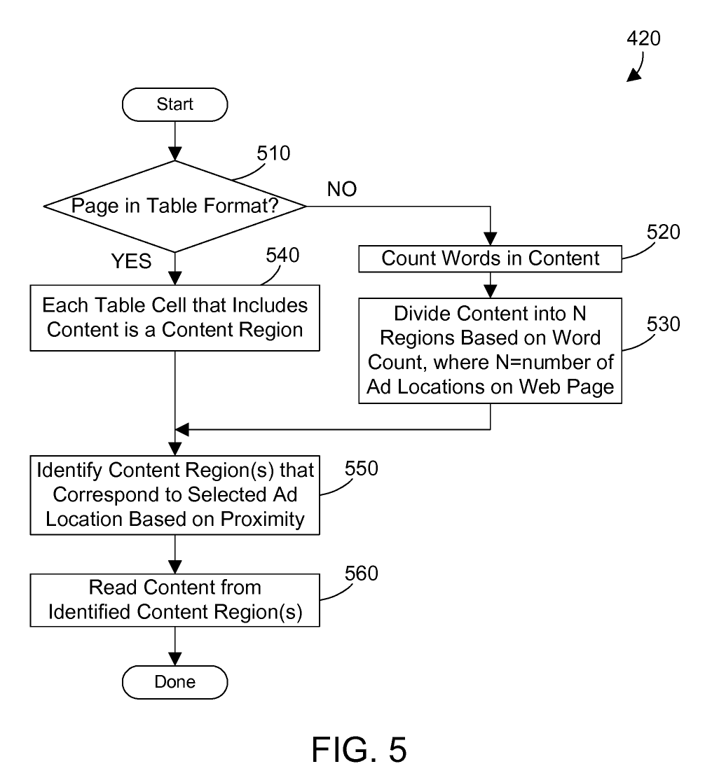

Referring to FIG. 5, a method 420 represents one suitable implementation for step 420 in FIG. 4. Method 420 first determines whether the page is in a table format (step 510). If not (step 510=NO), the words in the content are counted (step 520), and the content is divided into a number of content regions that corresponds to the number of ad locations on the web page based on word count (step 530). Thus, if the content includes 86 words, the first 43 words will be allocated to a first content region and the last 43 words will be allocated to a second content region. In this manner, method 420 may take content in a web page and divide that content into different regions according to the number of ad locations on the web page.

Next, the region or regions that correspond to the selected ad location based on proximity to the selected ad location are identified (step 550). The content is then read from the identified region(s) (step 560). If the page is in a table format (step 510=YES), each table cell that includes content is a content region (step 540). Steps 550 and 560 are then repeated as described above. In this manner, method 420 in FIG. 5 identifies content on a web page that corresponds to a selected ad location according to the proximity of the content to the ad location. The result is a selection of an ad according to content that is in closer proximity to the ad location, thereby achieving improved advertising on a web page.

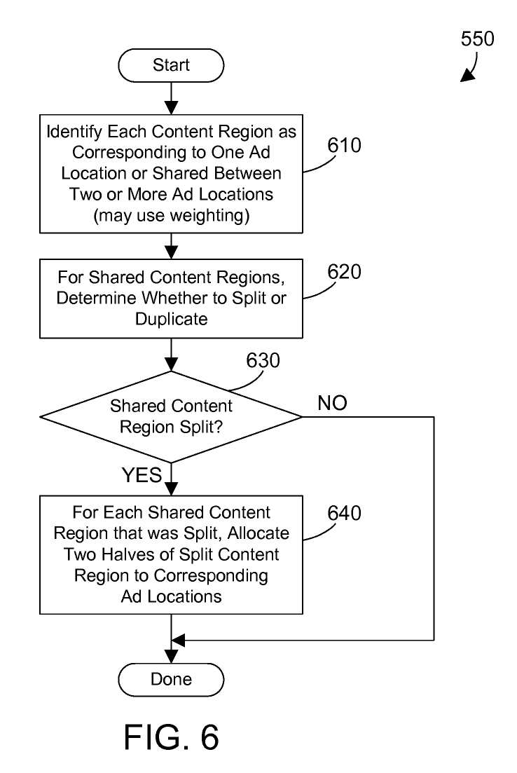

Referring to FIG. 6, a method 550 represents one suitable implementation of step 550 in FIG. 5. Method 550 begins by identifying each content region as corresponding to one ad location or as being shared between two or more ad locations (step 610). Note that step 610 may use any appropriate weighting scheme in identifying content that corresponds to a selected ad location. For shared content regions, a decision may then be made whether to split the content region or duplicate the content region. This decision may be made using any suitable heuristic. For example, if a content region has a first ad location immediately above it and a second ad location immediately below it, a reasonable decision would be to split the content region, allocating the top half (based on word count) to the first ad location and allocating the bottom half (based on word count) to the second ad location. If a content region has a first ad location immediately to its left and a second ad location immediately to its right, the content region could be split, or instead the content region could be duplicated by allocating the content in the content region to both ad locations. As used herein, the duplicating of a shared content region simply means the content in the shared content region corresponds to two or more ad locations, thus allowing the content in a shared content region to influence selection of ads at multiple ad locations. If the decision is made to split the content region (step 630=YES), each half of the split region is then allocated to the two corresponding ad locations (step 640). One very simple way to split a content region simply counts the words in the content region and divides the words according to the number of ad locations that share the content region. A split content region may then be treated as two separate content regions when selecting ads for the ad locations on a web page.

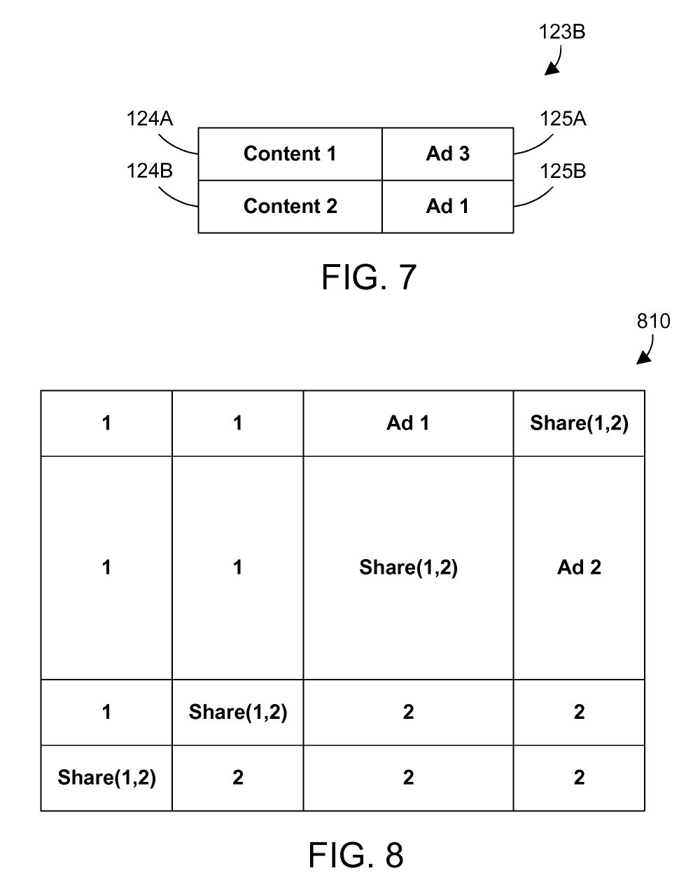

Referring to FIG. 7, a web page 123B is similar to the web page 123A shown in FIG. 2. The difference is the placement of ads in the ad locations 125A and 125B. We assume for this example that content region 124A corresponds to ad location 125A, and content region 124B corresponds to ad region 125B. As a result, the content in the content region 124A drives the selection of Ad 3 in ad location 125A, while the content in the content region 124B drives the selection of Ad 1 in ad location 125B. Note that the placement of the ads in web page 123B is thus different than the placement using the prior art techniques as shown in FIG. 2 because the ads in FIG. 7 are more intelligently placed according to content that is in closer proximity to the ads. Note that Ad 2 in FIG. 2 was not selected in FIG. 7. Instead, Ad 3 was selected based on the corresponding content in content region 124A. Note also that Ad 1 was placed in ad location 125B instead of ad location 125A (as in the prior art) because the content in the content region 124B drove the selection of Ad 1 for ad location 125B. Several examples are now presented to show some more complex examples that more effectively illustrate how proximity-based selection of ads for a web page results in better advertising on a web page.

Referring to FIG. 8, a sample web page 810 has a table-based form which is very common in the art. The table in FIG. 8 includes four rows and four columns that define sixteen cells in the table. We assume for this example that table 810 includes two ad locations designated Ad 1 and Ad 2. The remaining cells in the table contain content. The content in each cell can be designated for Ad 1, Ad 2, or may be shared between the two. One way to measure proximity of content to an ad location counts the number of cell boundaries crossed. We see from table 810 that five of the fourteen content cells correspond to Ad 1, as indicated by the “1” in the cells, five of the fourteen content cells correspond to Ad 2, as indicated by the “2” in the cells, and the remaining four cells are shared between Ad 1 and Ad 2.

Note that one or more of the shared cells may be divided according to word count, with the divisions then being allocated to one of Ad 1 and Ad 2. This approach is shown in web page 910 in FIG. 9, where the shared cells in web page 810 in FIG. 8 have been split approximately in half according to word count, and each half is then allocated to the ad location in the closest proximity. In the alternative, one or more of the shared cells in FIG. 8 may be allocated to both Ad 1 and Ad 2, which results in the content of these cells being included in the content that is used to select an ad at ad location Ad 1 and also being included in the content that is used to select an ad at ad location Ad 2.

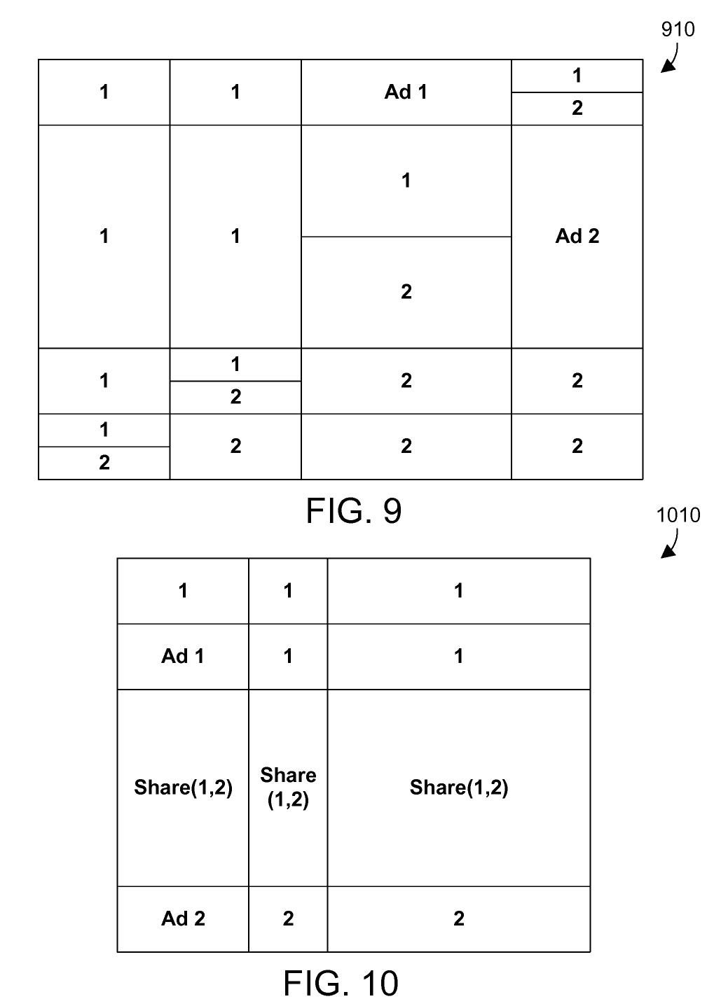

Referring to FIG. 10, a sample web page 1010 has a table-based form that includes four rows and three columns for a total of twelve cells, with two ad locations designated Ad 1 and Ad 2, and the remaining ten cells being content cells. Five of the ten content cells are allocated to Ad 1, as indicated by the “1” in the cells, two of the ten content cells correspond to Ad 2, as indicated by the “2” in the cells, and the remaining three cells are shared between Ad 1 and Ad 2. Note that the shared cells may be divided (as shown in FIG. 9) or duplicated (by allocating the content to multiple ad locations) as needed.

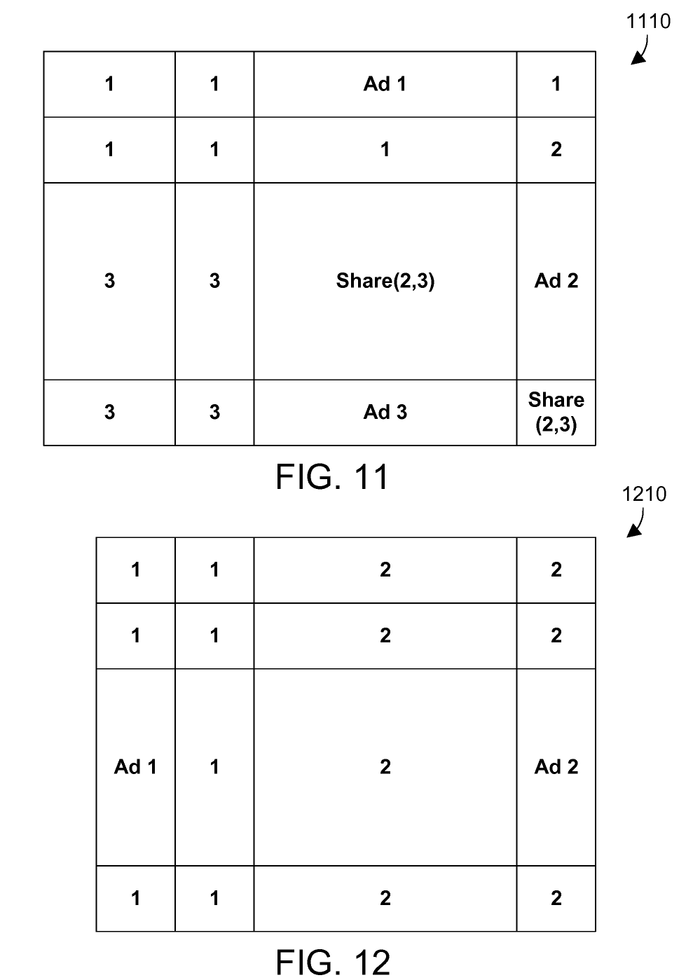

Referring to FIG. 11, a sample web page 1110 has a table-based form that includes four rows and four columns for a total of sixteen cells, with three ad locations designated Ad 1, Ad 2 and Ad3, and the remaining thirteen cells being content cells. Six of the thirteen content cells are allocated to Ad 1, as indicated by the “1” in the cells, one of the thirteen content cells correspond to Ad 2, as indicated by the “2” in the cell, four of the thirteen content cells are allocated to Ad 3, as indicated by the “3” in the cell, and the remaining two cells are shared between Ad 2 and Ad 3. Note that the shared cells may be divided or duplicated as needed. Web page 1110 in FIG. 11 shows how content may be allocated to ad locations based on proximity when more than two ad locations are present in a web page. The allocated content for an ad location is then used to drive selection of an ad for that ad location, resulting in placing ads in closer proximity to the text that influenced their selection.

Referring to FIG. 12, a sample web page 1210 has a table-based form that includes four rows and four columns for a total of sixteen cells, with two ad locations designated Ad 1, and Ad 2, and the remaining fourteen cells being content cells. Seven of the fourteen content cells are allocated to Ad 1, as indicated by the “1” in the cells, and the remaining seven content cells are allocated to Ad 2, as indicated by the “2” in the cell.

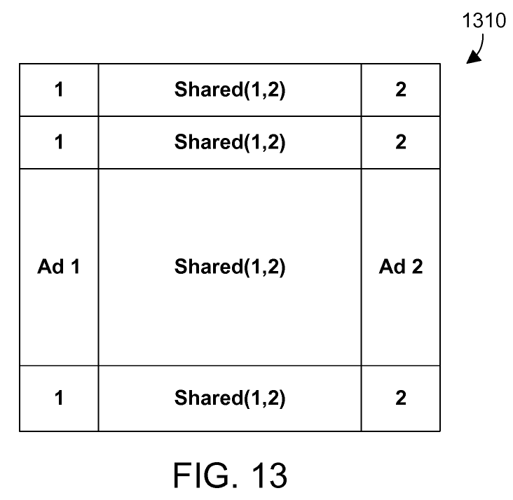

Referring to FIG. 13, a sample web page 1310 has a table-based form that includes four rows and three columns for a total of twelve cells, with two ad locations designated Ad 1 and Ad 2, and the remaining ten cells being content cells. Three of the ten content cells are allocated to Ad 1, as indicated by the “1” in the cells, three of the ten content cells correspond to Ad 2, as indicated by the “2” in the cell, and the remaining four cells are shared between Ad 1 and Ad 2. Note that the shared cells may be divided or duplicated as needed.

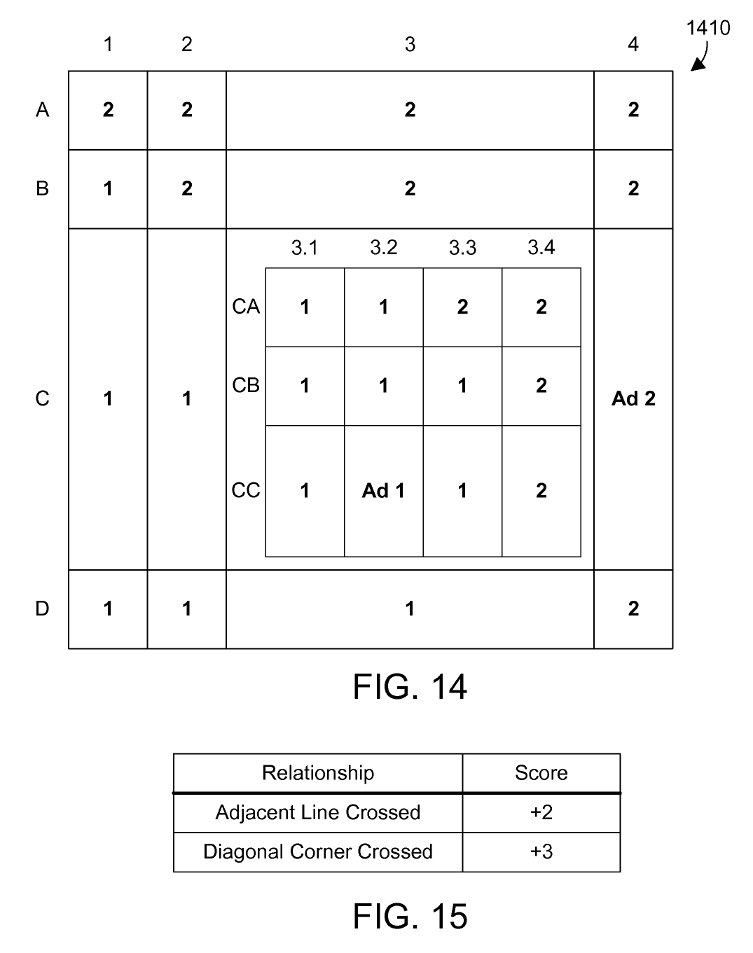

A more complex example of a web page is shown at 1410 in FIG. 14. Table 1410 has a table-based form that includes four rows and four columns for a total of sixteen cells. Note, however, that one of the cells includes a sub-table that has three rows and four columns, for a total of twelve cells in the sub-table. We assume there are two ad locations designated Ad 1 and Ad 2, and the remaining cells are content cells.

We now present a sample scoring scheme to allocate the content cells in table 1410 to one of the two ads in the table. This sample scoring scheme is very simple for the purpose of illustrating the concepts herein, and is shown by way of example in FIG. 15. Table 1510 in FIG. 15 shows that when an adjacent line is crossed, the score is incremented by two. When a diagonal corner is crossed, the score is increased by three. A score is calculated using this scoring scheme for each content block with respect to each ad location, and the content block is then allocated to the ad location that has the lowest score. Two examples follow to illustrate.

Note that the rows have been labeled A-D, and the columns have been labeled 1-4 for convenience in discussing web page 1410. In addition, the table at location C3 of the table has rows CA, CB and CC, and columns 3.1, 3.2, 3.3 and 3.4. We now consider location B2 to determine whether its content should be allocated to Ad 1, to Ad 2, or to both ad locations. The shortest path from B2 to Ad 1 is from B2 to CA3.1 to CB3.2 to CC3.2. In traversing this path, two corners are traversed and one adjacent line is traversed, so the score for Ad 1 at cell B2 is 3+3+2=8. We now score Ad 2 at B2. The shortest path is B2 to B3 to C4. In traversing this path, one adjacent line is traversed and one corner is traversed, so the score for Ad 2 at cell B2 is 2+3=5. Because cell B2 has a lower score for Ad 2, this cell is allocated to Ad 2, as shown by the “2” in cell B2. This scoring process may be repeated to determine the appropriate allocation of content to ad locations as shown in FIG. 14.

We now consider location B3 to determine whether its content should be allocated to Ad 1, to Ad 2, or to both ad locations. The shortest path from B3 to Ad 1 is from B3 to CA3.2 to CB3.2 to CC3.2. In traversing this path, three adjacent lines are traversed, so the score for Ad 1 at cell B3 is 2+2+2=6. We now score Ad 2 at B3. The shortest path is B3 to C4. In traversing this path, one corner is traversed, so the score for Ad 2 at cell B3 is 3. Because cell B3 has a lower score for Ad 2, this cell is allocated to Ad 2, as shown by the “2” in cell B2.

Note that any scoring scheme or any suitable heuristic may be used to allocate content to a corresponding ad location. Once the content in a web page is allocated to corresponding ad locations as shown in FIGS. 7-14, any suitable method, whether currently known or developed in the future, may be used to select an appropriate ad for the ad location based on the corresponding content.

We can see from the disclosure herein that allocating content in a web page to an ad location based on proximity of the content to the ad location results in a set of content that corresponds to an ad location that has a higher relevance based on proximity of the content to the ad location. The result is the ability to select ads based on content corresponding to an ad location, which results in proximity-based placement of ads in a web page. Ads that are more intelligently placed according to the proximity of content that drove their selection will likely improve the effectiveness of the ads.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. An apparatus comprising:
at least one processor;
a memory coupled to the at least one processor;
a web page residing in the memory that includes a plurality of content regions and a plurality of ad locations; and
a proximity-based ad placement mechanism that analyzes the plurality of content regions on the web page, and for each ad location on the web page, the proximity-based ad placement mechanism determines which of the plurality of content regions on the web page correspond to the ad location according to proximity of the plurality of content regions to the plurality of ad locations, analyzes content in at least one corresponding content region, and places an ad at the ad location based on the content in the at least one corresponding content region.

2. The apparatus of claim 1 further comprising a web server application that serves to a user the web page with a plurality of ads in each of the plurality of ad locations.

3. The apparatus of claim 1 wherein a selected content region on the web page corresponds to a selected ad location if the selected content region is closer in proximity to the selected ad location than to at least one other ad location.

4. The apparatus of claim 1 wherein a selected content region on the web page is identified as either corresponding to one ad location or being shared by a plurality of ad locations.

5. The apparatus of claim 4 wherein a content region that is shared by a plurality of ad locations is allocated to the plurality of ad locations by counting words in the content, dividing the content into N parts according to word count in the content, where N equals the number of the plurality of ad locations, and allocating each of the N parts to one of the plurality of ad locations.

6. The apparatus of claim 4 wherein a content region that is shared by a selected plurality of ad locations is allocated to all of the selected plurality of ad locations.

7. The apparatus of claim 1 wherein the web page includes a table and the plurality of content region in the web page include a plurality of cells in the table.

8. A method for placing a plurality of ads in a plurality of ad locations in a web page that includes a plurality of content locations, the method comprising the steps of:
for each ad location on the web page:
determining which of the plurality of content regions on the web page correspond to the ad location according to proximity of the plurality of content regions to the plurality of ad locations;
analyzing content in at least one corresponding content region; and
placing an ad at the ad location based on the content in the at least one corresponding content region.

9. The method of claim 8 further comprising the step of serving to a user the web page with a plurality of ads in each of the plurality of ad locations.

10. The method of claim 8 wherein a selected content region on the web page corresponds to a selected ad location if the selected content region is closer in proximity to the selected ad location than to at least one other ad location.

11. The method of claim 8 wherein a selected content region on the web page is identified as either corresponding to one ad location or being shared by a plurality of ad locations.

12. The method of claim 11 wherein a content region that is shared by a plurality of ad locations is allocated to the plurality of ad locations by counting words in the content, dividing the content into N parts according to word count in the content, where N equals the number of the plurality of ad locations, and allocating each of the N parts to one of the plurality of ad locations.

13. The method of claim 11 wherein a content region that is shared by a selected plurality of ad locations is allocated to all of the selected plurality of ad locations.

14. The method of claim 8 wherein the web page includes a table and the plurality of content region in the web page include a plurality of cells in the table.

15. A method for deploying computing infrastructure, comprising integrating computer readable code into a computing system, wherein the code in combination with the computing system perform the method of claim 8.

16. A computer-readable program product comprising:
a proximity-based ad placement mechanism that analyzes a plurality of content regions on a web page that includes a plurality of ad locations, and for each ad location on the web page, the proximity-based ad placement mechanism determines which of the plurality of content regions on the web page correspond to the ad location according to proximity of the plurality of content regions to the plurality of ad locations, analyzes content in at least one corresponding content region, and places an ad at the ad location based on the content in the at least one corresponding content region; and
recordable media bearing the proximity-based ad placement mechanism.

17. The program product of claim 16 wherein a selected content region on the web page corresponds to a selected ad location if the selected content region is closer in proximity to the selected ad location than to at least one other ad location.

18. The program product of claim 16 wherein a selected content region on the web page is identified as either corresponding to one ad location or being shared by a plurality of ad locations.

19. The program product of claim 18 wherein a content region that is shared by a plurality of ad locations is allocated to the plurality of ad locations by counting words in the content, dividing the content into N parts according to word count in the content, where N equals the number of the plurality of ad locations, and allocating each of the N parts to one of the plurality of ad locations.

20. The program product of claim 18 wherein a content region that is shared by a selected plurality of ad locations is allocated to all of the selected plurality of ad locations.
